(19) United States
(12) Patent Application Publication
(10) Pub. No.: US 2009/0244587 A1
(43) Pub. Date: Oct. 1, 2009

(54) IMAGE PROCESSING APPARATUS

(75) Inventor: Nobuyuki Tsukada, Kawaguchi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/411,030

(22) Filed: Mar. 25, 2009

(30) Foreign Application Priority Data
Mar. 27, 2008 (JP) 2008-083070

(51) Int. Cl. G06F 3/12

(52) U.S. Cl. 358/1.13

(57) ABSTRACT

An image processing apparatus acquires latest date/time information out of date/time information stored in the storage medium when image files are stored in a storage medium which stores image files containing date/time information that indicates date and time when generated. The image processing apparatus stores an image, adding the acquired date/time information to the image files. The image processing apparatus, when image files stored in the storage medium are output in order of date and time, arranges images in the order in reference to date/time information later added to the image files, in addition to date/time information initially contained in image files.

### BACKGROUND OF THE INVENTION

1. Field of the Invention

The present invention relates to an image processing apparatus that manages image files. More particularly, the present invention relates to an image processing apparatus that can display or print image data contained in the image files in order of date and time when the files were generated.

2. Description of the Related Art

Conventionally, a multifunction peripheral (MFP) as a multi-function image processing apparatus has a scanner, a printer, and a memory card slot. The MFP can implement a scanned image transmission function to transmit scanned images to a personal computer (PC), a copying function to directly print the scanned images, a memory card printing function to read out and print image data from a memory card inserted into a memory card slot, and other functions. Further, some MFPs have a scanned image saving function to directly save image data that has been read by a scanner as an image file in a storage medium such as a memory card.

Since a function to measure time is required if management of date and time like a calendar function, a clock function is to be performed in an image processing apparatus, batteries will be necessary for allowing the apparatus to continue to work even in a status in which a power source of the apparatus is cut off. For this reason, there exist many image processing apparatuses that do not have a function to measure time owing to battery cost.

In an image processing apparatus that does not incorporate such a function to measure time, when saving image data acquired by reading with a scanner, in a storage medium as an image file, actual date/time information cannot be added. As a result, a problem arises, for example, when an image file saved by an image processing apparatus that does not have a date/time management function, and an image file saved by another image processing apparatus such as a digital camera or the like that has a date/time management function are present at the same time in a plurality of image files. More specifically, when displaying a plurality of images on a liquid crystal screen in order of date and time based on such an image file group, only images which store date/time information are displayed in correct order, whereas images which do not store date/time information cannot be displayed in correct order. In addition, when a plurality of images are printed in order of date and time, the images can not be printed in correct order of date.

As a method for resolving such a problem, Japanese Patent Application Laid-Open No. 2001-175354 discusses a method in which an apparatus that does not have a function to measure time acquires date information from external devices when the apparatus is connected to a network. In this method, however, the image processing apparatus must be connected to a network, which requires terminals for this purpose, and thus the cost of the apparatus rises.

Further, in U.S. Pat. No. 6,816,620, if there is an image which was captured at unknown date and time when a silver-halide film is scanned and acquired images are saved as image data, approximate date/time information is estimated from date/time information of an image captured close to the image to be saved among silver-halide film images. However, in this method, there is a problem that the above-described estimation holds true only in the case where images are recorded in succession and in sequence like a silver-halide film, and their sequence is not altered. In other words, when images are displayed in lines, a user can freely set not only the order of date and time when images were generated, but also the order of file names and others. Therefore, once images have been arranged in order of file name, the date and time order will be misaligned, so that it will become impossible to presume date and time when image files were generated.

### SUMMARY OF THE INVENTION

The present invention is directed to an image processing apparatus that can output image data in correct sequence even if it does not have a date/time management function, in the case where image data is stored in a storage medium in which image data is stored by another image processing apparatus having a date/time management function, and a plurality of image data stored in the storage medium is output in order of date and time when they were generated.

According to an aspect of the present invention, an image processing apparatus that manages an image file in a first format containing date/time information indicating date and time when generated, and an image file in a second format that does not contain the date/time information, includes an attachment unit configured to attach an external storage medium, an acquisition unit configured to acquire latest date/time information out of first date/time information contained in an image file in a first format that is stored in an external storage medium attached to the attachment unit, a generation unit configured to generate image data, a storage control unit configured to store in the external storage medium an image file in a third format, adding date/time information acquired by the acquisition unit to an image file in a second format according to the image data generated by the generation unit as a second date/time information, and an output unit configured to output images in which image data contained in a plurality of image files stored in the external storage medium, is arranged in the order based on a first date/time information contained in an image file in a first format and a second date/time information added to an image file in a third format.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A is a view illustrating an outline of an image processing apparatus according to an exemplary embodiment of the present invention.

FIG. 1B is a view illustrating an outline of an image processing apparatus according to an exemplary embodiment of the present invention in a state that a document positioning plate cover is opened.

FIG. 2 is a block diagram illustrating functions of an image processing apparatus according to an exemplary embodiment of the invention.

FIG. 3 is a view illustrating an example of a menu screen displayed on a liquid crystal monitor of an operation unit.

FIG. 4 is a view illustrating operations when a memory card is inserted into an image processing apparatus.

FIG. 5 is a flowchart illustrating operations of a scanned image saving function.

FIG. 6 is a view illustrating an example of generation of additional date/time information in an exemplary embodiment of the present invention.

FIG. 7 is a view illustrating an entry sample of “additional date/time information”.

FIG. 8 is a flowchart of operations of “memory-card printing function”.

FIG. 9 is a view illustrating a display sample of an image data group read out from a memory card of images.

FIG. 10 is a view illustrating six images illustrated in FIG. 7 which are arranged in order of date and time.

FIG. 11 is a view illustrating a result of index print.

### DETAILED DESCRIPTION OF THE EMBODIMENTS

Various exemplary embodiments, features, and aspects of the invention will be described in detail below with reference to the drawings.

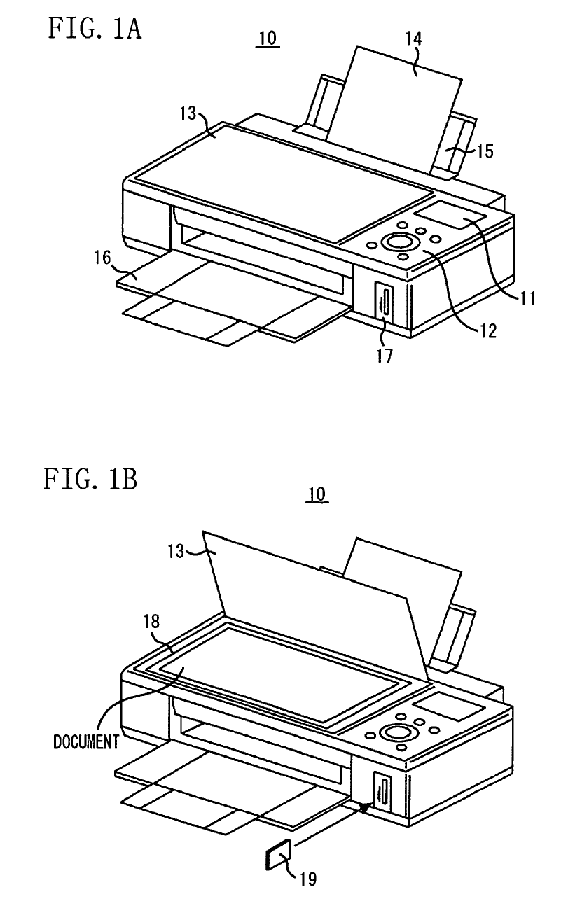

FIG. 1A is a view illustrating an outline of an image processing apparatus according to an exemplary embodiment of the present invention. An image processing apparatus 10 includes a liquid crystal monitor 11, an operation panel 12, a document positioning plate cover 13, a paper feed tray 15, a paper discharge tray 16, and a memory card connector 17. The liquid crystal monitor 11 displays a status of the apparatus, and images read out from the memory card 19. The operation panel 12 includes push buttons (not shown), and serves as an operation panel for a user conducting apparatus control. The document positioning plate cover 13 protects a document positioning plate. The paper feed tray 15 inserts printing paper 14. The paper discharge tray 16 receives the printing paper 14 after printing. A memory card is inserted into the memory card connector 17.

FIG. 1B is a view illustrating an image processing apparatus while the document positioning plate cover 13 is opened. When the document positioning plate cover 13 is opened, the document positioning plate 18 is exposed to allow a user to set a document. In addition, a memory card 19 is inserted into the memory card connector 17, so that data can be read out via the memory card connector 17. An SD card and a memory stick can be attached to the memory card connector 17, but not limited thereto as long as it is an external storage medium.

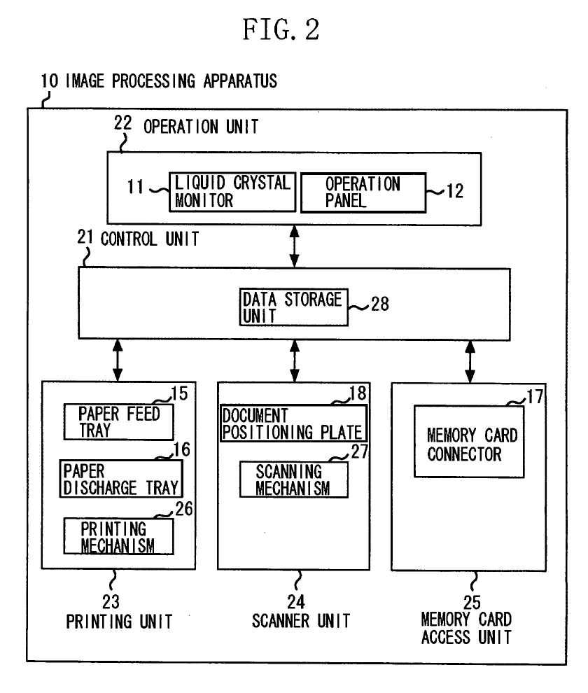

FIG. 2 is block diagram illustrating functions of an image processing apparatus 10 according to the present exemplary embodiment. The image processing apparatus 10 includes a control unit 21 that controls the image processing apparatus 10, an operation unit 22, a printing unit 23, a scanner unit 24, and a memory card access unit 25. The control unit 21 controls the entire image processing apparatus 10 when central processing unit (CPU) (not shown) executes a program saved in a read-only memory (ROM), and includes a non-volatile data storage unit 28. The non-volatile data storage unit 28 stores latest date/time information and serial numbers as described below.

The operation unit 22 includes the liquid crystal monitor 11, and the operation panel 12. The liquid crystal monitor 11 can display image data read out from storage media, and notifies a user by displaying the status of the apparatus. The operation panel 12 receives instructions from the user. The printing unit 23 performs a series of printing operations, more specifically, printing pieces of printing paper set in a paper feed tray 15 by a printing mechanism 26, and discharging the pieces of printing paper to a paper discharge tray 16 after printing. The scanner unit 24 has a scanning mechanism 27, which optically reads out a document placed on a document positioning plate 18 to generate image data. The memory card access unit 25 allows a memory card 19 inserted into the memory card connector 17 to save image data, and inversely reads out image data saved in the memory card 19.

In the image processing apparatus 10, the following four functions are achieved according to operations by a user from the operation unit 22 by combining these sections.
(1) “copying function” to print images with the printing unit 23 according to image data read out from the scanner unit 24.
(2) “memory card image printing” to print images with the printing unit 23 according to image data read out from the memory card 19 by the memory card access unit 25.
(3) “scanned image saving function” to save image data read out from the scanner unit in the memory card 19 with the memory card access unit 25.
(4) “apparatus setting function” to perform setting of the entire apparatus.

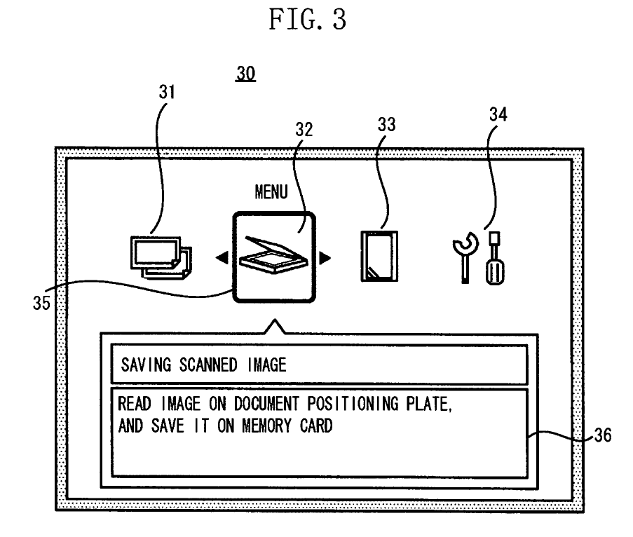

Next, the processing of an image processing apparatus 10 will be specifically described below. FIG. 3 is a view illustrating a sample of a menu screen displayed on the liquid crystal monitor 11 of the operation unit 22. When a power source of the image processing apparatus 10 is turned on, a menu screen 30 illustrated in FIG. 3 is displayed on the liquid crystal monitor 11, and a desired function can be achieved when a user selects a corresponding icon on this menu screen 30. An icon 31 denotes above-described “copying function”, and an icon 32 denotes above-described “scanned image saving function”. An icon 33 denotes above-described “memory card image printing function”, and an icon 34 denotes “apparatus setting function” to perform setting of the entire apparatus. A cursor 35 shows an icon currently being selected. A guide 36 is a display region where description of an icon on which the cursor 35 is being put is given. A user puts the cursor 35 on an icon of a function that the user wants to execute using the operation panel 12, and then presses OK key (not shown) to execute a desired function.

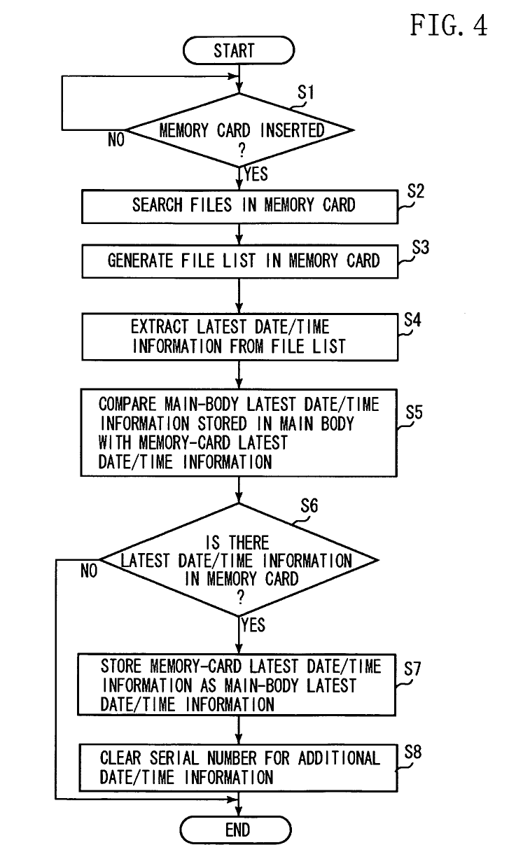

First, operations performed when the memory card 19 is inserted into the image processing apparatus 10 will be described below. FIG. 4 is a view illustrating operations when the memory card 19 is inserted into the image processing apparatus 10. In step S1, the image processing apparatus 10 checks whether the memory card 19 has been inserted. If the memory card 19 is inserted (YES in step S1), then in step S2, the image processing apparatus 10 retrieves files in the memory card 19. In step S3, the image processing apparatus 10 acquires “date/time information” of respective files according to a specific file format to generate a file list. File formats in the present exemplary embodiment are FAT 32, EXIF and other standard specifications, and above-described “date/time information” is information contained in the files in these file formats, which indicates date and time when images were generated. The “date/time information” is stored in a region prescribed by the specifications in a file, and can be acquired by reading it out from the region.

Next, in step S4, the image processing apparatus 10 extracts the newest date/time information (memory-card latest date/time information) from date/time information of the generated file list, then in step S5, compares it with “latest date/time information” (main-body latest date/time information) saved in the non-volatile data storage unit 28 of the control unit 21. Instep S6, the image processing apparatus 10 checks whether there is newer date/time information in the file list than current main-body latest date/time information. If there is not newer date/time information in the file list than current main-body latest date/time information (NO in step S6), the process terminates. On the other hand, if there is newer date/time information (YES in step S6), then in step S7, the image processing apparatus 10 stores the date/time information in the non-volatile data storage unit 28 as “latest date/time information”. Further, the non-volatile data storage unit 28 stores also serial numbers for generating additional date/time information (described below), then in step S8, the image processing apparatus 10 clears the serial number to 0 when the above-described “latest date/time information” is updated.

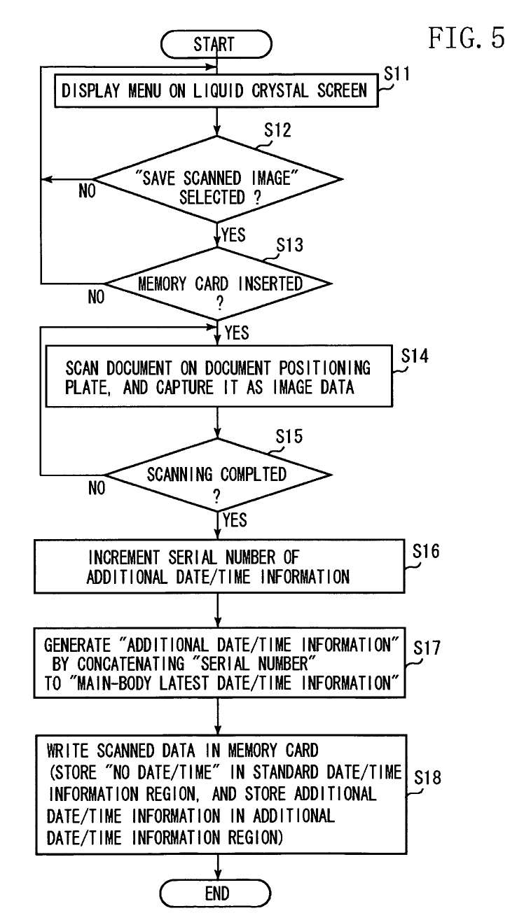

Next, operations in a scanned image saving function will be described. FIG. 5 is a flowchart illustrating operations of the scanned image saving function. The scanned image saving function is a function to read out documents such as photographs and papers placed on a document positioning plate 18 by an optical sensor of the scanning mechanism 27, and to save image data acquired by the scanning in the memory card 19 inserted into the memory card connector 17

First, in step S11, the image processing apparatus 10 displays the menu screen 30 on the liquid crystal monitor 11. In step S12, if a user does not select the icon 32 (NO in step S12), the process returns to step S11. On the other hand, if the user selects the icon 32 (YES in step S12), then in step S13, the image processing apparatus 10 checks whether the memory card 19 is properly inserted. If the memory card 19 is not inserted (NO in step S13), the process returns to step S11. On the other hand, if the memory card 19 is properly inserted (YES in step S13), then in step S14, the image processing apparatus 10 scans a document placed on the document positioning plate 18 to capture image data. Next, in step S15, the image processing apparatus 10 checks whether the reading of the document is completed. If the scanning is not completed (NO in step S15), the process returns to step S14. On the other hand, if the scanning is completed (YES in step S15), then in step S16, the image processing apparatus 10 increments the above-described serial number stored in the non-volatile data storage unit 28 by one. In step S17, the image processing apparatus 10 generates “additional date/time information” by concatenating the above-described serial number to the above-described “latest date/time information”. Finally, in step S18, the image processing apparatus 10 adds the above-described “additional date/time information”, and saves image data read out from the document in the memory card 19.

In the process of S18, the image processing apparatus 10 saves image files in EXIF format. However, the above-described “additional date/time information” is stored in a region where any information can be written (hereinafter referred to as additional date/time information region) instead of a region where normally, date and time is held (hereinafter referred to as standard date/time information region) using image files in EXIF format. At this time, a value indicating that date/time information is not present is written in the standard date/time information region. The “additional date/time information” is not written in a normal region because “additional date/time information” is not exact date/time information. In other words, date/time information stored in the region is information to which other image processing apparatuses make reference, and therefore additional date/time information, which is quasi-date/time information, is not stored therein.

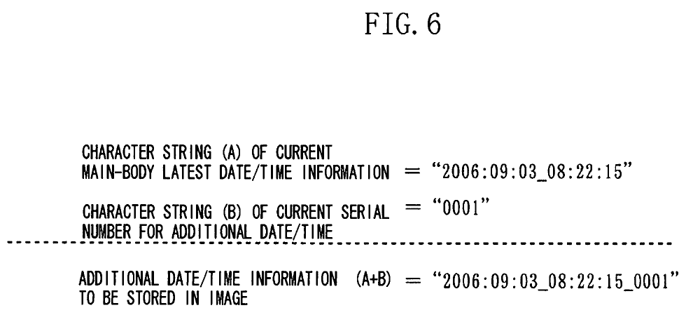

FIG. 6 is a view illustrating a sample of generation of additional date/time information in the present exemplary embodiment. In the sample, a character string for latest date/time information is “2006:09:03_{—}08:22:15”, and serial number is a character string “0001”. The “additional date/time information” generated in this case is a character string “2006:09:03_{—}08:22:15_{—}0001” that is formed by concatenating above two strings with “_”. The serial number is added to additional date/time information because even if a plurality of scanned images are saved in a state that latest date/time information has not been updated, they are prevented from becoming the same “additional date/time information”.

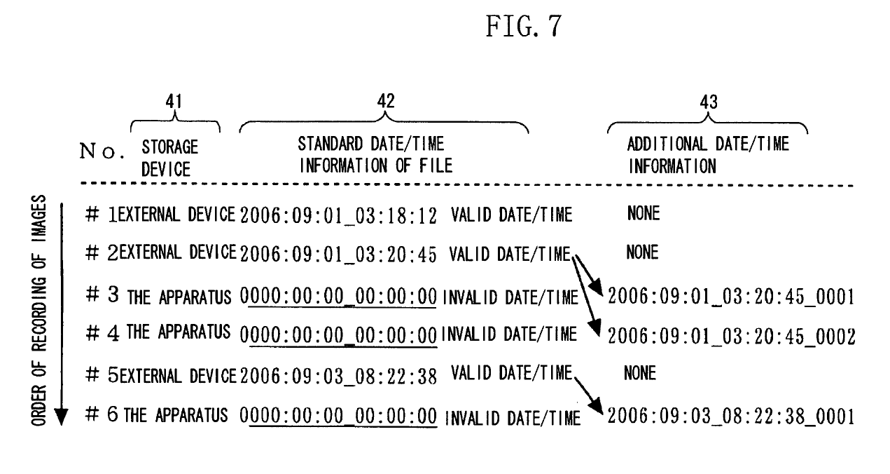

FIG. 7 is a view illustrating an entry sample of “additional date/time information”. In the entry sample as illustrated in FIG. 7, devices 41 that have stored images, “standard date/time information” 42 stored in standard date/time information region in mage files in EXIF format, and “additional date/time information” 43 stored in additional date/time information region are entered. In this sample, #3, #4, and #6 denote image data that the image processing apparatus according to the present exemplary embodiment has saved, and #1, #2, and #5 denote image data that an external device (e.g., digital camera) having a function to manage data and time has saved.

A storage status of each image will be described below in time series.
(1) A memory card is inserted into a digital camera, and an #1 image (“2006:09:01_{—}03:18:12”) and #2 image (“2006:09:01_{—}03:20:45”) are saved therein to which dates and times of actual photographing are added.
(2) When the memory card is inserted into the image processing apparatus 10, standard date/time information of images in the memory card is retrieved, and date/time information “2006:09:01_{—}03:20:45” of an #2 image that is the newest date/time is stored as latest date/time information.
(3) Consecutively, scanned image data #3 and #4 in the memory card are saved by a scanned image saving function in the image processing apparatus 10. In this moment, invalid date/time (“0000:00:00_{—}00:00:00”) is entered as standard date/time information. Then, “2006:09:01_{—}03:20:45_{—}0001”, and “2006:09:01_{—}03:20:45_{—}0002” are stored with serial numbers concatenated to latest date/time information as additional date/time information.
(4) Then the memory card is connected again to the digital camera, and an #5 image is saved to which “2006:09:03_{—}08:22:38” representing date/time of actual photographing is added as standard date/time information.
(5) When the memory card is inserted again into the image processing apparatus 10, standard date/time information in the memory card is retrieved again, and “2006:09:03_{—}08:22:38” of date/time information of #5 is stored as a new latest date/time information.
(6) Consecutively, scanned image data #6 is saved in the memory card by above-described scanned image saving function. In this moment, invalid date/time (“0000:00:00_{—}00:00:00”) is stored in the standard date/time information region, and “2006:09:03_{—}08:22:38_{—}0001” is stored with serial number concatenated to latest date/time information in the additional date/time information region.

As described above, with respect to image data #1, #2, and #5 written by the external device having time measuring function, valid date/time information is written in the standard date/time information region 42. On the other hand, with respect to #3, #4, and #6 stored by the image processing apparatus 10 that does not have time measuring function, date/time is not stored in the standard date/time information region 42. However, additional date/time information with serial number added to latest date/time information is separately stored in the additional date/time information region 43. Thus, additional date/time information” different from “standard date/time information” is newly added to image data and saved as image file, thereby display order when image data is displayed utilizing the additional date/time information can be made satisfactory.

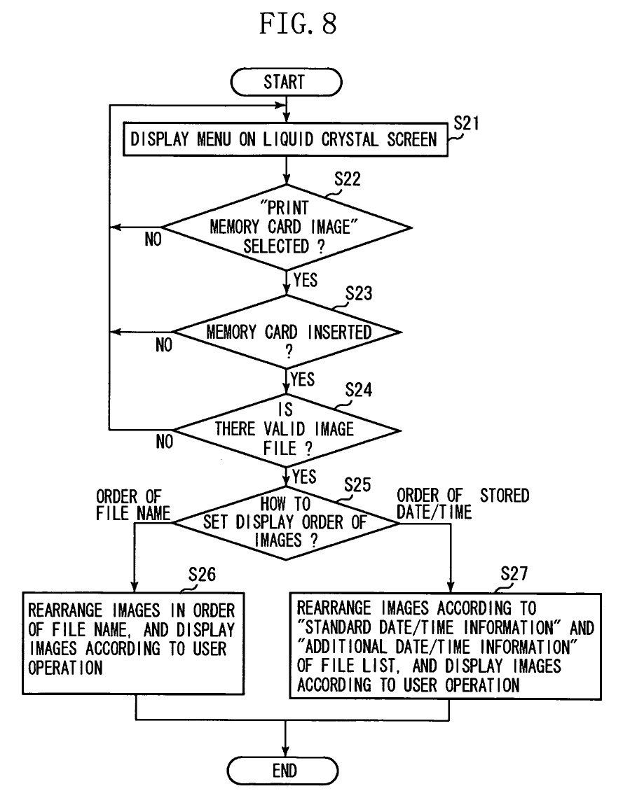

FIG. 8 is a flowchart illustrating operations of “memory card printing function”. First, in step S21, the image processing apparatus 10 displays the menu screen 30 on the liquid crystal monitor 11, then in step S22, checks whether a user has selected an icon 33. If the icon 33 is not selected (NO in step S22), the process returns to step S21. On the other hand, if the icon 33 is selected (YES in step S22), then in step S23, the image processing apparatus 10 checks whether the memory card is properly inserted. If the memory card is not inserted (NO in step S23), the process returns to step S21. On the other hand, if the memory is properly inserted (YES in step S23), then in step S24, the image processing apparatus 10 checks whether there is image data that can be displayed. If there is not image data that can be displayed (NO in step S24), the process returns to step S21. On the other hand, if the image data can be displayed (YES in step S24), then in step S25, the image processing apparatus 10 checks display order of images that has been set. Here, it is assumed that order of file name and order of stored date/time can be set as display order of images. If above-described screen display is set in “order of file name”, then in step S26, the image processing apparatus 10 arranges images in order of file name, and displays them. On the other hand, if above-described screen display is set in “order of stored date/time”, then in step S27, the image processing apparatus 10 arranges images in order of date and time and displays the images in an image content 51 within the memory card.

A method for arranging images “in order of stored date/time” will be described below. First, if an image contains valid “standard date/time information”, the image processing apparatus 10 reads out its character string. If there is no valid “standard date/time information”, it reads out character string stored in “additional date/time information”. Then, the image processing apparatus 10 determines the order of images by comparing character strings of respective images.

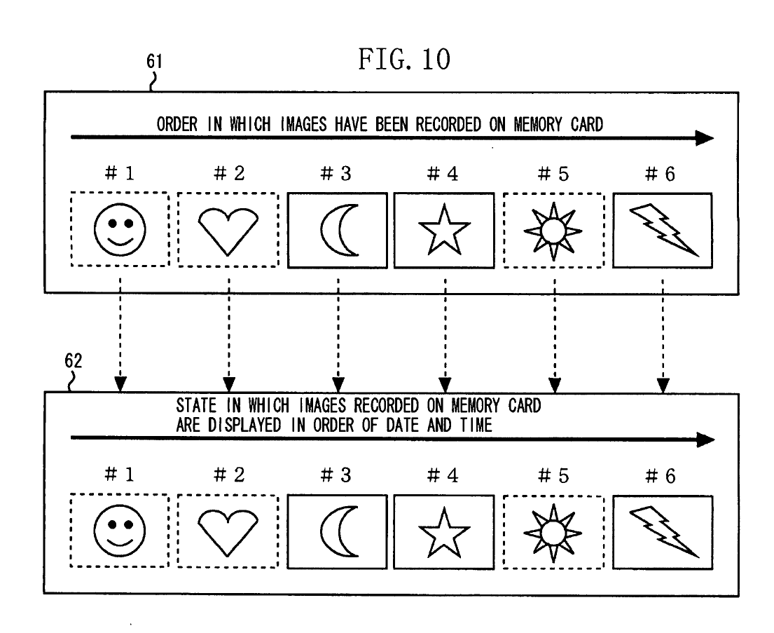

FIG. 10 is a view illustrating a state in which six images as illustrated in FIG. 7 are arranged in order of date and time. A display sample 61 is arranged in the order in which images have been actually generated on the memory card, and a display sample 62 shows a result obtained when the images have been arranged in order of date and time. As illustrated in FIG. 10, by arranging images according to two kinds of information of “additional date/time information”, and “standard date/time information”, images can be displayed in the same order as the order of actual image saving. In the present method in which images are arranged according to two kinds of information of “additional date/time information”, and “standard date/time information”, the order of images cannot totally agree with the order of real time. However, as described above, images can be displayed in more approximate order closer to the order of real time as compared with a conventional method in which images are arranged only according to “standard date/time information”.

In the present exemplary embodiment, it is assumed that an apparatus that executes the processing to save images as illustrated in FIG. 4 and an apparatus that executes the processing to read out images as illustrated in FIG. 8 are the same, but the present invention is not limited to the embodiment. Therefore, a maker-note region may also be used as additional date/time information region, so that reference may be made to this region in a specific apparatus. In that case, also in the specific apparatus, it is possible to display images arranged according to additional date/time information.

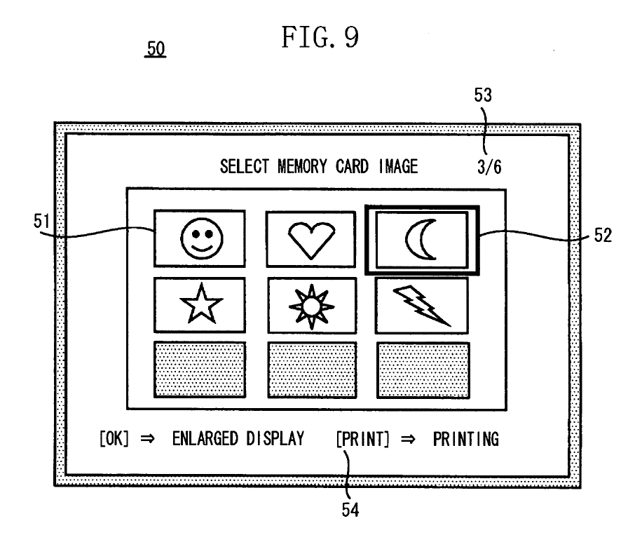

FIG. 9 is a view illustrating a display sample of image data group read out from a memory card of images. On an image selection screen 50, an image content 51 in the memory card, an image selection cursor 52 indicating an image currently selected, and an image number 53 indicating the number of an image currently selected and total number of images are displayed. FIG. 9 illustrates the third image selected out of six images that have been saved on the memory card. A key guide display 54 instructs a user about the valid key operation. When OK key (not shown) is pressed, an image at cursor position is displayed in enlarged form (not shown), and when a PRINT key (not shown) is pressed, index print (described below) can be conducted. The image content 51 in the memory card is changed in their arrangement order according to an image display order setting. The image display order setting is one of items to be set on a setting screen (not shown) on which icons 34 of a menu screen 30 as illustrated in FIG. 3 were selected. It is determined by the image display order setting whether images are displayed in order of date and time, or displayed in order of file name. FIG. 9 illustrates an example in which images are displayed in order of date and time. However, if setting is made in order of file name, arrangement order of images will be changed over. The displayed images may be image data with a high resolution contained in image files, or may be images with a low resolution like thumbnail images that are added to image files in Exif format.

Further, while the above description relates to a display order of images, a printing order when images are printed, is similar to the display order of images. For example, in the image processing apparatus 10, when PRINT key (not shown) is pressed on the image selection screen 50, index print can be performed to print a plurality of images in lines on printing paper with respect to all images on the memory card. Further, according to the exemplary embodiment, not only images can be displayed and printed in lines, but also regions for displaying or printing can be differentiated according to date/time information. Furthermore, only images that agree with date/time information designated by a user can be displayed or printed.

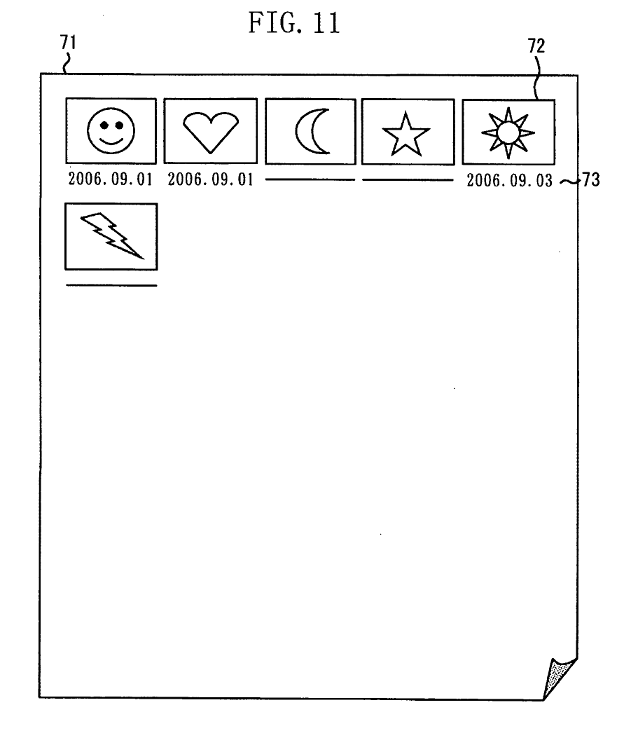

FIG. 11 is a view illustrating a result of index print. In FIG. 11, printing paper 71 on which printing was conducted, printed images 72, and date information 73 of the images are illustrated. In the exemplary embodiment, correct arrangement order of images can be achieved in printing by arranging images in order of date and time according to “standard date/time information” and “additional date/time information”. Further, in the exemplary embodiment, character strings indicating date and time are printed only with respect to images which store “standard date/time information” while character strings indicating date and time are not printed with respect to images which store “additional date/time information”. As a consequence, a user is prevented from confusing “additional date/time information” (i.e., quasi date/time information) with actual date/time information.

Further, in the exemplary embodiment as described above, when external storage medium such as a memory card is attached, date/time information is acquired to update latest date/time information. However, the present invention is not limited to the embodiment. The image processing apparatus may also acquire latest date/time information in the memory card when an image file is generated. Further, a control unit in the present exemplary embodiment adds date/time information to image data input from a scanner unit. However, the present invention is not limited the exemplary embodiment. Date/time information may also be added when photographs are taken, for example, with a camera that does not have date/time management function. Furthermore, date/time information may also be added to image data that has been, for example, input from another apparatus via an interface (not shown).

Furthermore, in the above description, an external storage medium such as a memory card is inserted, but the exemplary embodiment is not limited thereto. Namely, images may be saved in a memory within the image processing apparatus. In this case, an image processing apparatus such as a digital camera having date/time management function can be connected via an universal serial bus (USB) or the like, to input and save an image file having date/time information.

As described above, in the present exemplary embodiment, the newest date and time among “standard date/time information” that has been read out so far is stored, and “additional date/time information” based thereon is added to image data to be saved. Then, images are arranged according to above-described “standard date/time information” or “additional date/time information” for display or print. As a consequence, when images saved in an image information processing apparatus that does not have date/time management function, and images stored in an external device that has date/time management function, are arranged for display or print, they can be arranged in an order close to actual date and time.

While the present invention has been described with reference to the exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-083070 filed Mar. 27, 2008, which is hereby incorporated by reference herein in its entirety.

What is claimed is:

1. An image processing apparatus that manages an image file in a first format containing date/time information indicating date and time when generated, and an image file in a second format that does not contain the date/time information, the image processing apparatus comprising:
an attachment unit configured to attach an external storage medium;
an acquisition unit configured to acquire latest date/time information out of first date/time information contained in an image file in a first format that is stored in the external storage medium attached to the attachment unit;
a generation unit configured to generate image data;
a storage control unit configured to store in the external storage medium an image file in a third format in which the date/time information acquired by the acquisition unit is added as a second date/time information to an image file in a second format according to the image data generated by the generation unit; and
an output unit configured to output images in which image data contained in a plurality of image files stored in the external storage medium, is arranged in an order based on the first date/time information contained in the image file in the first format and the second date/time information added to the image file in the third format.

2. The image processing apparatus according to claim 1, further comprising:
a storage unit configured to store data;
wherein the acquisition unit stores the acquired latest date/time information in the storage unit, and when the external storage medium is attached to the attachment unit, the acquisition unit acquires the latest date/time information and updates the date/time information stored in the storage unit.

3. The image processing apparatus according to claim 2, wherein, when the image data is generated, the date/time information stored in the storage unit is added to the image data.

4. The image processing apparatus according to claim 1, further comprising:
a reading unit configured to read out a document; wherein the generation unit generates the image data obtained by reading out a document with the reading unit.

5. The image processing apparatus according to claim 1, wherein the storage control unit adds identification information indicating order of generation to the image data generated by the generation unit, and the output unit outputs images in which a plurality of image data contained in image files in the third format having the same date and time that a second date/time information indicates, is arranged in order according to the identification information.

6. The image processing apparatus according to claim 1, wherein the output unit outputs images that contain date and time indicated by the first date/time information contained in the image file in the first format and do not contain date and time indicated by the second date/time information added to the image file in the third format.

7. The image processing apparatus according to claim 1, further comprising:
a display unit configured to display images;
wherein the output unit outputs the images in which the image data contained in the plurality of image files is arranged in lines, to the display unit to display the images.

8. The image processing apparatus according to claim 1, further comprising:
a printing unit configured to print images on printing paper;
wherein the output unit outputs the images in which the image data contained in the plurality of image files is arranged in lines, to the printing unit to print the images.

9. The image processing apparatus according to claim 1, wherein with respect to the image file in the third format, information indicating invalid is stored in a first region where the first date/time information is saved, and the second date/time information is stored in a second region different from the first region.

10. The image processing apparatus according to claim 1, wherein the first format is EXIF format.

11. An image processing apparatus that manages an image file in a first format containing date/time information that indicates date and time when generated, and an image file in a second format that does not contain the date/time information, the image processing apparatus comprising:
an attachment unit configured to attach an external storage medium;
an acquisition unit configured to acquire latest date/time information out of first date/time information contained in an image file in a first format that is stored in the external storage medium attached to the attachment unit;
a generation unit configured to generate image data; and
a storage control unit configured to store in the external storage medium an image file in a third format in which the date/time information acquired by the acquisition unit is added to an image file in a second format according to the image data generated by the generation unit, as a second date/time information.
